(19) United States
(12) Patent Application Publication
(10) Pub. No.: US 2003/0108788 A1
(43) Pub. Date: Jun. 12, 2003

(54) Sodium-sulfur battery

(76) Inventors: Tadahiko Miyoshi, Hitachi (JP); Manabu Madokoro, Hitachi (JP); Yasuji Kusakabe, Hitachi (JP); Hisamitsu Hatou, Hitachi (JP); Minoru Kobayashi, Hitachi (JP); Kenzou Kikuchi, Kitaibaraki (JP); Shigeru Sakaguchi, Hitachi (JP); Seiichi Komatsu, Hitachi (JP); Tetsuya Sado, Juo (JP)

Correspondence Address: DICKSTEIN SHAPIRO MORIN & OSHINSKY LLP, 2101 L STREET NW, WASHINGTON, DC, 20037-1526, US

(21) Appl. No.: 10/246,703

(22) Filed: Sep. 19, 2002

(30) Foreign Application Priority Data
Dec. 10, 2001 (JP) 2001-375310

(51) Int. Cl. H01M 10/39

(52) U.S. Cl. 429/104; 429/164

(57) ABSTRACT

The object of the present invention is to provide a sodium-sulfur battery suitable for use in an electric power storage system and an electric vehicle, wherein said battery permits reconciling improvement in battery efficiency with enlargement in battery capacity.

A sodium-sulfur battery comprising an anode chamber 4 having a pouchy tube of solid electrolyte 1 inside of which is filled with liquid sodium; a cathode chamber 5 arranged outside of said pouchy tube of solid electrolyte 1, said cathode chamber 5 accommodating a cathode active material 14 comprising at least one of sulfur and sodium polysulfide; a collector 11 provided inside of said anode chamber 4; and at least one of a porous conductor 12 and a porous material 13 that fills the space between said collector 11 and the side face of said pouchy tube of solid electrolyte 1, wherein said pouchy tube of solid electrolyte 1 is laid horizontally or aslant; said collector 11, in its cross-sectional construction, has a protruded room 110 on at least a part thereof which faces the lower section of the side face of said pouchy tube of solid electrolyte 1; and said protruded room 110 is filled with at least one of said porous conductor 12 and said porous material 13.

### BACKGROUND OF THE INVENTION

1. Field of the Invention

The present invention relates to the construction of a sodium-sulfur battery suitable to an electric power storage system and an electric vehicle.

2. Description of the Prior Art

A sodium-sulfur battery is in the limelight for the promised application to an electric power storage system, an electric vehicle, and a hybrid car as well. Because, the battery has a long service life and a high energy density. This type of battery has the construction that enables to offer such high performance, in which a cathode chamber is filled with liquid sodium and an anode chamber with a cathode active material such as sulfur or sodium polysulfide, or both; and the anode chamber is separated from the cathode chamber with a pouchy tube of solid electrolyte made of the beta alumina-ceramics of β or β″ type.

Practical use of this battery indispensably requires the battery to have high reliability, assured safety while use, and lowered cost. For fulfillment of these requirements, it is desired to reduce the internal resistance for improved battery efficiency, or to enlarge the scale of unit cell for reduced number of cells per output-kW or per output-kWh. However, measures taken in prior batteries for these problems are not enough. In this connection, it should be noted that a low battery efficiency invites a low battery output resulting in a increased number of the cell per output-kW or output-kWh involving higher cost.

For cost lowering, large-sizing of a unit cell is particularly useful to enlarge the battery capacity. However, this requires a pouchy tube of solid electrolyte to have increased height or width, or both. As common applications tell, there is a problem in the battery efficiency when a pouchy tube of solid electrolyte is laid vertically and its height is increased. In this configuration, a vertical gradation in concentration and composition of an active material tends to appear due to gravity. This gradation causes uneven distribution of electromotive force within the battery, which generates a circulating local current resulting in lowered battery efficiency.

Alternative to increasing the height of the pouchy tube of solid electrolyte, increasing the width thereof is also practicable. However, this practice increases the ratio of volume to surface area of the pouchy tube of solid electrolyte. This increased ratio requires the operating current density to be intensified in order to complete the reaction of the active material, which is filled in the pouchy tube of solid electrolyte is filled, within specified time length. As a result, the battery efficiency becomes lower due to the effect of the internal resistance.

As stated above, improvement of battery efficiency for lower cost by reducing internal resistance was not compatible with large-sizing of the sodium-sulfur battery capacity by the prior art.

As a measure for this problem, we have applied a patent for a sodium-sulfur battery in which a pouchy tube of solid electrolyte is laid flat, i.e. horizontally or aslant. This application has been disclosed in Japanese Patent Laid-Open Nos. 2001-76754 and 2001-243975. However, a study on an optimized structure of cathode has not been fully conducted in the proposed battery. This means that the study for improved charging/discharging performance was also not enough. To achieve continued cost lowering therefore, enlargement in the capacity, improvement in charging/discharging performance, and enhancement in mechanical reliability are inevitable to contribute to realization of increasingly improved cathode structure. Although a battery having a flat-laid structure has been described in Japanese Patent Laid-Open Nos. 57-145278 (U.S. Pat. No. 4,396,688) and 47-19321, the studies in these inventions for enlargement in the battery capacity and for improved battery performance are still not enough.

### SUMMARY OF THE INVENTION

The purpose of the present invention is to provide a sodium-sulfur battery that enables to reconcile upgraded battery efficiency based on improved charging/discharging performance and enlarging the battery capacity.

A first sodium-sulfur battery according to the present invention is comprised of: an anode chamber having a pouchy tube of solid electrolyte inside of which is filled with liquid sodium; a cathode chamber arranged outside of said pouchy tube having one closed tip end of solid electrolyte, said cathode chamber accommodating a cathode active material comprising at least one of sulfur and sodium polysulfide; a collector provided inside of said anode chamber; and at least one of a porous conductor and a porous material that fills the space between said collector and the side face of said pouchy tube of solid electrolyte, wherein said pouchy tube of solid electrolyte is laid horizontally or aslant; said collector, in its cross-sectional construction, has a protruded room on at least a part thereof which faces the lower section of the side face of said pouchy tube of solid electrolyte; and said protruded room is filled with at least one of said porous conductor and said porous material.

In this structure, it is preferred that a part of at least one of said porous conductor and said porous material is spread continuously from the vicinity of the side face of said pouchy tube of solid electrolyte to the top of said protruded room; or alternatively that at least one of members of the group of portions consisting of said top of protruded room, a part of the upper section of side face of said collector, and the whole of said upper section is arranged onto a cathode casing that forms said cathode chamber in a practice selected from the group of joining practices consisting of contacting, jointing, and integrating. Otherwise, use of both of these structures is also a preferred mode.

The second sodium-sulfur battery according to the present invention is comprised of: an anode chamber having a pouchy tube of solid electrolyte inside of which is filled with liquid sodium; a cathode chamber arranged outside of said pouchy tube of solid electrolyte, said cathode chamber accommodating a cathode active material comprising at least one of sulfur and sodium polysulfide; a collector provided inside of said anode chamber; and at least one of a porous conductor and a porous material that fills the space between said collector and the side face of said pouchy tube of solid electrolyte, wherein said pouchy tube of solid electrolyte is laid horizontally or aslant; volume of the space produced between the lower section of the side face of said pouchy tube of solid electrolyte and a cathode casing that forms said cathode chamber is larger than volume of the space produced between the upper section of the side face of said pouchy tube of solid electrolyte and said cathode casing that forms said cathode chamber.

In this structure, it is preferred that said collector, in its cross-sectional construction, has a protruded room on at least a part thereof which faces the lower section of the side face of said pouchy tube of solid electrolyte; and said protruded room is filled with at least one of said porous conductor and said porous material; or alternatively that a part of at least one of said porous conductor and said porous material is spread continuously from the vicinity of the side face of said pouchy tube of solid electrolyte to the top of said protruded room. Otherwise, use of both of these structures is also a preferred mode.

The third sodium-sulfur battery according to the present invention is comprised of: an anode chamber having a pouchy tube of solid electrolyte inside of which is filled with liquid sodium; a cathode chamber arranged outside of said pouchy tube of solid electrolyte, said cathode chamber accommodating a cathode active material comprising at least one of sulfur and sodium polysulfide; a collector provided inside of said anode chamber; and at least one of a porous conductor and a porous material that fills the space between said collector and the side face of said pouchy tube of solid electrolyte, wherein the cross-section of a cathode casing that forms said cathode chamber is oval; and said pouchy tube of solid electrolyte is laid horizontally or aslant so that the minor axis of said oval shape may position vertical.

The fourth sodium-sulfur battery according to the present invention is comprised of: an anode chamber having a pouchy tube of solid electrolyte inside of which is filled with liquid sodium; a cathode chamber arranged outside of said pouchy tube of solid electrolyte, said cathode chamber accommodating a cathode active material comprising at least one of sulfur and sodium polysulfide; a collector provided inside of said anode chamber; and at least one of a porous conductor and a porous material that fills the space between said collector and the side face of said pouchy tube of solid electrolyte, wherein said pouchy tube of solid electrolyte is laidhorizontally or aslant; and volume of a space in said cathode chamber for the axially outer portion from the bottom of said pouchy tube of solid electrolyte is larger than volume of a space produced between a part of side face of said collector which faces said pouchy tube of solid electrolyte and the lower section of the side face of said cathode casing that forms said cathode chamber.

Thus, according to said first to fourth sodium-sulfur batteries, a sodium-sulfur battery that is capable of reconciling upgraded battery efficiency based on improved charging/discharging performance and enlarging the battery capacity becomes practicable.

In said first to fourth sodium-sulfur batteries described above, it is preferred that the space produced between one of the lower portions of the side faces of said collector and said pouchy tube of solid electrolyte, and a cathode casing that forms said cathode chamber is filled with at least one of a porous conductor and a porous material.

The fifth sodium-sulfur battery according to the present invention is comprised of: an anode chamber having a pouchy tube of solid electrolyte inside of which is filled with liquid sodium; an anode chamber arranged outside of said pouchy tube of solid electrolyte, said cathode chamber accommodating a cathode active material comprising at least one of sulfur and sodium polysulfide; a collector provided inside of said anode chamber; and at least one of a porous conductor and a porous material that fills the space between said collector and said pouchy tube of solid electrolyte, wherein the cross-section of a cathode casing that forms said cathode chamber is any one of shapes of oval and rectangular; said pouchy tube of solid electrolyte is laid horizontally or aslant so that the minor axis in said cross-sectional shape may position vertical; and said pouchy tube of solid electrolyte is provided with a supporting plate therein, which is installed vertically along the minor axis thereof.

In said fifth sodium-sulfur battery, it is preferred that the distribution of wall thickness of said cathode casing is given one of features that the wall thickness along the major axis of the rectangular shape thereof is larger than that along the minor axis and that the wall thickness in proximity to the minor axis of the oval shape in said cathode casing is larger than that in proximity to the major axis thereof, and that said sodium-sulfide battery is given at least one of constitutions selected from the group of constitution styles consisting of that said supporting plate has a through-hole thereon and that said cathode chamber has a room therein at the portion between the crosswise-end of said supporting plate and said cathode casing.

Thus, according to said fifth sodium-sulfur battery, a highly reliable sodium-sulfur battery that is capable of reconciling upgraded battery efficiency based on improved charging/discharging performance and enlarging the battery capacity becomes practicable.

According to the present invention, compatibility of large-capacity with improved efficiency in a sodium-sulfur battery becomes practicable enabling realization of a low cost battery. Further according to the present preferred embodiment, the mechanical reliability of a cathode casing that composes a part of a battery can be improved.

### BRIEF DESCRIPTION OF THE DRAWINGS

FIG. 1 is a sectional schematic view of the sodium-sulfur battery according to the embodiment 1.

FIG. 2 is a schematic sectional view of the sodium-sulfur battery according to the embodiment 2.

FIG. 3 is a schematic sectional view of the sodium-sulfur battery according to the embodiment 3.

FIG. 4 is a schematic sectional view of the sodium-sulfur battery according to the embodiment 4.

### DESCRIPTION OF THE PREFERRED EMBODIMENTS

(Embodiment 1)

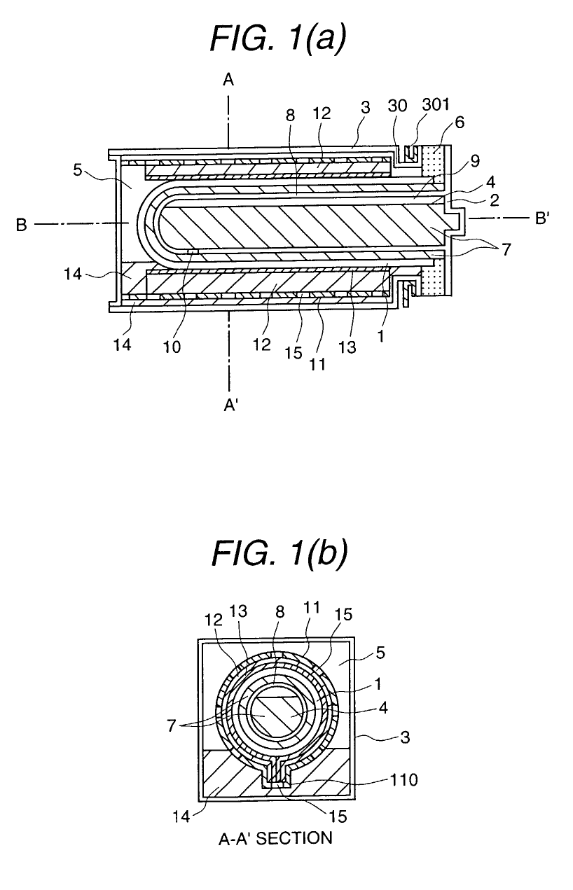

FIG. 1 is a cross-sectional view to schematically show construction of a sodium-sulfur battery according to the present invention. A pouchy tube of solid electrolyte 1, which has sodium-ionic conduction, usually uses a solid electrolyte composed of the beta alumina-ceramic of β or β″ type. In the present invention, a pouchy tube of solid electrolyte is laid either horizontally or aslant.

An anode casing 2 and a cathode casing 3, together with the pouchy tube of solid electrolyte 1, constitute an anode chamber 4 and a cathode chamber 5 respectively. Usually, these casings use Al, Fe, or SUS as the constituent material; otherwise, as a common alternative to this, these are also used with anti-corrosion layer being given thereon composed mainly of Cr, Mo, Ti, C, or Si. A clad metal of Al-alloy and SUS is also generally applicable.

On the other hand, an insulator 6 electrically separates the anode casing 2 from the cathode casing 3. The insulator 6, installed to join these casings, usually uses α alumina-ceramics as its material. Further, although details are not illustrated, this insulator 6 is glass-joined to near the opening of the pouchy tube of solid electrolyte 1, or is sintered into one-body with the opening of the pouchy tube of solid electrolyte 1 using ceramics like a alumina or magnesium-aluminum-spinel. At the jointing portions on the insulator 6 to the anode casing 2 and to the cathode casing 3, Al or Al-alloy is used as the joining material although not illustrated. In this joining practice, hot-press welding is usually employed, in which heat is controlled below liquidus temperature of the joining material or solidus temperature of the same.

In the anode chamber 4, a sodium container 8 made of metal, such as SUS or Al, is installed to accommodate a liquid sodium 7. The sodium container 8 has a through-hole 10 thereon to pass the sodium 7. In the discharging stage, the sodium 7 is pressed to pass through the through-hole 10 by gravity and the pressure of an inert gas 9 like nitrogen or Ar charged in the sodium container 8 which forms a part of the anode chamber. In the charging stage, the sodium 7 is pressed by the pressure of an incoming sodium penetrating the pouchy tube of solid electrolyte 1 to pass the through-hole 10 on the sodium container 8.

This arrangement of the sodium container 8 reduces quantity of the sodium 7 existing adjacent to the pouchy tube of solid electrolyte 1 and improves battery safety in case of breakage of the pouchy tube of solid electrolyte 1. Although, in FIG. 1, the sodium container 8 is one-bodied with the anode casing 2, another configuration in which said sodium container 8 and said anode casing 2 are in separate arrangement can be practicable.

On the surface of the cathode casing 3 joined to the insulator 6, a support 301 is installed. The support 301 is made of ferritic or austenitic material like SUS; or ferroalloy containing iron as its main component with the addition agent of about 1 to 10% of Cr together with, if preferred, about 0.2 to 1% of Mo and/or about 0.3 to 3% of Si. When the cathode casing 3 uses Al or Al-alloy, joining the support 301 to the surface of the cathode casing 3 at the part thereof opposite to the joining part to the insulator 6 works as a relaxation element for the stress on the joining part caused by the difference of thermal expansion coefficient between the cathode casing 3 and the insulator 6.

A similar construction can be applicable to the joining part of the anode casing 2 although such is not shown in the drawing. This support 301 increases the reliability of the battery structure against rise and fall in the temperature by limiting the axial elastic deformation of a bellows 30 provided on the cathode casing 3 caused from rise and fall of the battery temperature.

A collector 11, which connects to the cathode casing 3 on the lateral end thereof, is provided along the outer side face of the pouchy tube of solid electrolyte 1 in the cathode chamber 5. A porous conductor 12 and a porous material 13 are installed between the collector 11 and the side face of the pouchy tube of solid electrolyte 1. The cathode chamber 5 is filled with a cathode active material 14 comprised of either sulfur or sodium polysulfide, or both. Said cathode active material 14 accelerates battery reaction infiltrating into the porous conductor 12 and the porous material 13.

In this configuration, a carbon fiber or a carbon powder aggregate is used for the porous conductor 12. Particularly, the carbon fiber mat based on PAN (polyacrylonitrile), treated under a temperature of 1200 to 2000° C., or the one based on pitch, each having a radial thickness of 1 to 20 mm along the pouchy tube of solid electrolyte 1, is preferred. Alternatively, use of a ring-shaped carbon fiber mat with fibers arrayed in a face-wise spread increases the battery efficiency, wherein the face-wise portion of the carbon fiber mat is arranged perpendicular to the side face of the pouchy tube of solid electrolyte 1 to reduce the resistance of the carbon fiber mat along the radial direction of the pouchy tube of solid electrolyte 1.

Similar effect is realized when a rectangular or trapezoid shaped carbon fiber mat is used as the porous conductor 12. The resistance of the carbon fiber mat is reduced in a manner that: arraying a greater part of the carbon fibers parallel with the face of the carbon fiber mat; cutting the carbon fiber mat into a rectangular or trapezoid shape in the plane perpendicular to the face of carbon fiber mat; and helically winding or cylindrically applying the rectangular or trapezoid shaped carbon fiber mat on the pouchy tube of solid electrolyte 1 so that the face of the carbon fiber mat may come perpendicular to the side face of the pouchy tube of solid electrolyte 1 thereof.

Distribution of the fiber density in the carbon fiber mat can be made relatively even by helically winding the trapezoid-cut carbon fiber mat on the pouchy tube of solid electrolyte 1 with the arrangement wherein the short side of the trapezoid closely contacts the pouchy tube of solid electrolyte 1 and the long side faces outward.

The porous material 13 usually uses an aggregation of ceramic fibers or particles like alumina or an aggregation of glass fibers or glass particles. The preferred thickness in this application is about 0.1 to 0.5 mm along the radial direction of the pouchy tube of solid electrolyte 1. Although no illustration is given, it is possible to allow eased movement of the cathode active material 14 within the porous conductor 12 by: piling and stuffing the carbon fiber mat in axial-wise to the pouchy tube of solid electrolyte 1; filling the space among piled carbon fiber mats with a porous material; or providing a metal plate having a through-hole thereon.

The battery capacity will be enlarged by increasing the quantity of the cathode active material 14 more than the void volume in the porous conductor 12 or the porous material 13 so that a liquid phase pool of the cathode active material 14 may be produced outside of the collector 11 in the cathode chamber 5 in excess of impregnation into the porous conductor 12 and the porous material 13, and by providing a through-hole 15 on the collector 11 to let the cathode active material 14 move into or go out of the porous conductor 12.

The collector 11 uses Al, Al-alloy, or clad of these metals with SUS, wherein their thicknesses are about 0.3 to 5 mm. On the contact surface of the collector 11 with the porous conductor 12, an anti-corrosion layer is provided by thermal spraying or plating, wherein said anti-corrosion layer is comprised typically of: Co-based alloy, Cr/Fe alloy, Al/Si alloy, SUS, Cr, C, or Mo; or carbide or nitride of Cr or Mo. Alternatively, particles or fibers of these anti-corrosion materials may be joined onto said contact surface, or embedded otherwise.

The through-hole 15 is a circular opening having about 1 to 10 mm of diameter or a rectangular opening having similar dimensions in its width or length; alternatively, a slit having a width of 1 to 10 mm may be provided among these holes and openings. The area of these holes, openings, or slits is preferred to be 5 to 50% of the area of the collector 11.

As shown in A-A′ cross-sectional view in FIG. 1, the cross-sectional construction of the collector 11 has a protruded room 110 of square shape at the radial-lower part of its circular portion, i.e. the bottom of its side face. In this configuration, it is also practicable to shape the protruded room 110 in other protrusion style like triangle, half round, or half oval; the protruded room 110 may be provided on a part of or over the whole area of the collector 11 although these styles are not shown in the drawing. Alternatively, the protruded room may be provided on the radial-upper part of or in flank of the collector 11.

As a further modification, the cross-sectional construction of the collector 11 may be shaped in a oval or a polygon like square to form the protruded room 110 on the under-surface thereof lateral to the pouchy tube of solid electrolyte 1.

A part of both the porous conductor 12 and the porous material 13 is extended continuously from the surface of the pouchy tube of solid electrolyte 1 to the top of the protruded room 110 on the collector 11. Although drawing does not show, either the porous conductor 12 or the porous material 13 may be continuously extended. Alternatively, inside the protruded room 110 can be filled with a porous conductive matter similar to the porous conductor 12 or with a porous substance similar to the porous material 13.

Further, although no illustration is given, the space existing between the top end of the protruded room 110 and the cathode casing 3 can be filled with either a porous conductive matter or a porous substance.

In the sodium-sulfur battery having the construction shown in FIG. 1, the pouchy tube of solid electrolyte 1 is laid flat, i.e. horizontally or aslant and current is collected by the collector 11 in the cathode chamber 5 installed along the pouchy tube of solid electrolyte 1. Therefore, when the pouchy tube of solid electrolyte 1 is given a larger length than its diameter like usual dimensioning, the height of the battery becomes lower than the height when the pouchy tube of solid electrolyte 1 is held upright. This reduced height causes the vertical gradation in the concentration and composition of the cathode active material 14 attributable to the gravity hard to occur. Consequently, the gradation of electromotive force within the battery and accompanying circulating local current are also become hard to occur with improved battery efficiency.

The cause of the gradation of composition is that the sodium polysulfide, a constituent of the cathode active material 14, is not soluble in sulfur and is heavier than sulfur in specific gravity, then it pools on the bottom of the cathode chamber; and that the electromotive forces within the cathode chamber 5 differ depending on the portions where the sodium polysulfide exists and where the sulfur exists.

Further, the battery efficiency is improved by the current collection using the collector 11 installed along the pouchy tube of solid electrolyte 1, because this arrangement of the collector makes the thickness of the porous conductor 12 retained in the space between the pouchy tube of solid electrolyte 1 and the collector 11 relatively thin with reduced resistance for improved efficiency.

As shown in FIG. 1, the cross-sectional construction of the collector 11 has a protruded room 110 at the radial-lower part of its circular portion, i.e. the bottom of its side face; thereby the gap between the circular portion of the collector 11 and the side face of the pouchy tube of solid electrolyte 1 can be maintained almost even. Consequently, the electrical resistance across thickness of the porous conductor 12 becomes almost uniform offering an advantage which permits the current distribution to be easily equalized.

When the pouchy tube of solid electrolyte 1 is retained aslant, the angle between the axis of the pouchy tube of solid electrolyte 1 and the horizontal axis is preferred to be within ±45° so that the vertical height of the battery may be reduced.

As will be detailed later in this specification, considering the absorbed-height of the cathode active material 14 by the surface tension of the porous conductor 12 and the porous material 13, it is preferred that the pouchy tube of solid electrolyte 1 to be retained at an angle such that the vertical height of the porous conductor 12 and the porous material 13 are below 15 cm. Reduction of the vertical height of the battery for improved battery efficiency particularly requires aligning the pouchy tube of solid electrolyte 1 horizontally.

This arrangement is notably effective in the capacity-enlarging for a unit cell by lengthening the pouchy tube of solid electrolyte 1, which allows capacity-enlarging to be compatible with upgraded efficiency by use of the constitution in the present invention.

In the charging stage of the sodium-sulfur battery, the sodium polysulfide, the cathode active material 14, is absorbed up by the surface tension in the porous material 13 and the porous conductor 12 from the liquid phase of the cathode active material 14 pooled outside the collector 11. The absorbed-up cathode active material 14 is electrolyzed in the porous conductor 13 producing sodium ion. This ion must move into the anode chamber 4 through the pouchy tube of solid electrolyte 1. Further, as the charging progresses, the liquid level of the cathode active material 14 in the cathode chamber 5 becomes low, which prevents the sodium polysulfide, which composes the cathode active material 14, form contacting with the porous material and porous conductor inviting the interruption problem in charging.

To improve the battery capacity coping with this problem, it is preferred to use a construction that allows the sodium polysulfide in the cathode chamber 5 easily contact with the porous material 13 and the porous conductor 12. Although the sodium polysulfide moves relying on the surface tension of the porous material 13 and the porous conductor 12, contact with the porous material 13 is of particular preference because the sodium polysulfide has an easy wettability with the porous material 13 more than that with the porous conductor 12.

In contrast to this, the sulfur, which is a part of the cathode active material 14, has an easy wettability with the porous conductor 12.

In the discharging stage of the sodium-polysulfide battery, the sulfur, the cathode active material 14 impregnated in the porous conductor 12, reacts to sodium ion supplied from the anode chamber 4 through the pouchy tube of solid electrolyte 1. This reaction produces sodium polysulfide, which should be discharged out of the porous conductor 12 into the space inside the cathode chamber 5 arranged outside the collector 11.

If discharging of the sodium polysulfide is hard to take place, the sodium polysulfide heavily reacts to the sodium ion supplied from the anode chamber 4 to produce a sodium polysulfide of heavy atomic weight of sodium. This material lowers the electromotive force of battery with problem of lowered battery efficiency that depends on the electromotive force and resistance of battery.

The battery efficiency is defined as: (Electromotive Force−Resistance×Current)/(Electromotive Force+Resistance×Current)

Regarding to these problems, the following should be noted. In the space within the cathode chamber 5 in which the liquid phase of sulfur, the cathode active material 14, exists along the outer face of the porous conductor 12, the sodium polysulfide in the porous conductor 12 and sulfur in the space within the cathode chamber 5 tends to be exchanged each other because of easy-wettability of the sulfur with carbon fibers and carbon particles that constitute the porous conductor 12. Consequently, the sodium polysulfide can be easily discharged from the porous conductor 12.

In an area within the space between the cathode chamber 5 and the porous conductor 12 filled with a gas or being vacuum, the sodium polysulfide is easily discharged from the porous conductor 12 into the space inside the cathode chamber 5 by gravity and discharging progresses. On the other hand, in an area within said space occupied by the liquid phase of the sodium polysulfide, the cathode active material 14, the sodium polysulfide in the porous conductor 12 is hard to be discharged into the space within the cathode chamber 5.

To cope these problems, the constitution according to the present invention shown in FIG. 1 retains the pouchy tube of solid electrolyte 1 horizontally or aslant. In this constitution, the collector 11 having the protruded room 110 on the bottom of its side face is placed adjacent to the side face of the pouchy tube of solid electrolyte 1; and the spaces between the side face of the pouchy tube of solid electrolyte and the collector 11, and inside the protruded room are filled with the porous conductor 12 and/or the porous material 13.

With this arrangement, the sodium polysulfide accommodated in the lower space in the cathode chamber 5 is absorbed up through its contact with the porous material 13 and the porous conductor 12 in the protruded room 110. Thus, the sodium polysulfide pooled on the bottom of the cathode chamber 5 comes contributable to charging offering an advantage of being improved battery capacity.

For this purpose, the porous material 13 and the porous conductor 12 are preferred to be continuously spread or extended from the vicinity of the surface of the pouchy tube of solid electrolyte 1 to the top of the protruded room 110. With this arrangement, the porous material 13 and the porous conductor 12 work as a continuous one-body making the surface tension function effectively allowing eased absorbing up of the sodium polysulfide for the advantage: smooth progress of charging even under a large charging current.

As an alternative to the above, filling inside the protruded room 110 with a porous conductive material composed of a similar matter to the porous conductor 12 or with a porous substance composed of a similar matter to the porous material 13 may be practicable. In this arrangement, it is preferred that the porous conductive material and the porous substance filling inside the protruded room 110 should tightly contact with the surface of the porous conductor 12 and the surface of the porous material 13.

Further, although not illustrated, it is also practicable to arrange the top of the protruded room 110 close to the cathode casing 3 or to bring them into contact. Thereby, even the sodium polysulfide pooling at the lowest part of the cathode chamber 5 can contact with the porous material and the porous conductor in the protruded room causing particularly improved battery capacity.

Also it becomes practicable to use absorb-up effect due to the surface tension of the sodium polysulfide with the preparation: filling the space between the under portion of the top of the protruded room 110 and the cathode casing 3 with a porous conductive material or a porous substance composed of a similar matter to the porous conductor 12 or the porous material 13; and making these materials contact with the porous conductor or the porous material.

In the constitution according to the present invention, a portion of the porous conductor 12 around the pouchy tube of solid electrolyte 1, occupies an area relatively distant from the bottom part of the side face of the cathode casing 3. Also in said constitution, the sodium polysulfide accumulates in the lower portion of the liquid phase thereof pooled in the cathode chamber 5 because of greater specific gravity than that of sulfur. Therefore, in the space within the cathode chamber 5, an area of which around the outer face of the porous conductor 12 becomes to have a little portion such that the sodium polysulfide exists in liquid phase. Then, the lager area in the cathode chamber 5 around the outer face of the porous conductor 12 becomes being filled with sulfur or a gas, or being vacuum.

As the result of this, the sodium polysulfide produced in the porous conductor 12 at the time of the battery discharging is easily released from the collector 11 into the space within the cathode chamber 5 allowing the battery's discharging to progress smoothly with improved discharging capacity of the battery.

As stated in the above, a high efficiency and large capacity battery having excellent discharging performance is realized using the constitution specified in the present invention.

For more improvement in the discharging capacity than stated above, it is preferred to position the center axis B-B′ of the pouchy tube of solid electrolyte 1 above the center of the cathode chamber 5 so that the volume of the upper half portion of the space between the side face of the pouchy tube of solid electrolyte 1 and the cathode casing 3 may be larger than the volume of the lower half portion thereof.

Thereby, the volume in the cathode chamber 5 for the portion below the center axis B-B′ of the pouchy tube of solid electrolyte 1 becomes larger allowing the battery to discharge without difficulty with improved discharging capacity.

Because of this constitution, the liquid level of the sodium polysulfide, which is produced through sodium ion's reaction, discharged into the space within the cathode chamber 5 becomes relatively lower than the height of the porous conductor 12 provided along the pouchy tube of solid electrolyte 1. As the result of this, when the sodium polysulfide is produced to a predetermined amount, the area in the outer face of the porous conductor 12 along the space in the cathode chamber 5 for the portion in which the sodium polysulfide exists becomes relatively small.

There is another advantage on the other hand. The area in the outer face of the porous conductor 12 in the cathode chamber 5 where sulfur or gas exists or where vacuum is produced becomes relatively large. Then discharging in the sodium-sulfur battery proceeds smoothly with enlarged battery capacity and enhanced battery efficiency.

When the porous conductor 12 is positioned relatively upper part of the cathode chamber 5 like the above-mentioned style, making the pressure of an inert gas, like nitrogen or argon, in the cathode chamber 5 be below the vapor pressure of the sulfur at the operating temperature, or alternatively, evacuating said cathode chamber 5 is preferable to allow the sulfur, the cathode active material 14, to be supplied to the upper portion of the porous conductor 12 for smooth discharging. Thereby, the sulfur contacts the porous conductor 12 and is supplied thereto in a form of liquid and also in a form of gas contributing to a smooth discharging to realize improved battery efficiency and enlarged battery capacity.

In the constitution shown in FIG. 1, the collector 11 is provided in the cathode chamber 5 and the shape of the side face of the cathode casing 3 is rectangular.

Provision of the collector 11 in this manner makes the resistance of the battery little changeable even when the shape of the cathode casing 3 is altered. Therefore, when the pouchy tube of solid electrolyte 1 is retained horizontally or aslant, it becomes practicable that the top and bottom faces and/or both of the lateral faces of the cathode casing 3 are made flat and parallel each other, and that, as a preferred arrangement, said top and bottom faces and lateral faces are all made flat and parallel each other, i.e. the sectional shape of the cathode casing 3 is made square or rectangular as shown in the cross-sectional view in FIG. 1.

Making the top and bottom faces of the cathode casing 3 into the flat-and-parallel configuration, i.e. horizontal-flat, prevents easy movement of the battery in flat installation with improved posture stability. In accommodating the plurality of sodium-sulfur batteries in the insulating container that composes a module, this configuration further offers reduced vertical interstice between vertically stacked batteries and minimized vertical clearance between batteries and the insulating container. This means that the accommodation density of the module is improved with increased energy density. Further, making the lateral faces of the cathode casing 3 into the flat-and-parallel configuration offers reduced horizontal interstice between batteries accommodated in the insulating container and minimized horizontal clearance between batteries and the insulating container. This means that the energy density of the module is improved.

For particular improvement in the energy density of the module, it is preferred to make the cathode casing 3 square or rectangular in its cross section. Thereby, vertical and horizontal interstice between batteries and their clearance between the insulating container are reduced.

To improve the mechanical reliability of the pouchy tube of solid electrolyte 1 laid flat, although not illustrated, the top of the protruded room 110 provided on the collector 11 is preferred to be in contact with the cathode casing 3, or alternatively, to be joined or one-bodied. Thereby, load or moment that the pouchy tube of solid electrolyte 1 may suffer when retained horizontally or aslant is born by the collector 11 through the porous conductor 12 and porous material 13 contributing to improved mechanical reliability of the sodium-sulfur battery. Alternatively, joining or one-bodying upper portion, i.e. radial-upper portion shown in FIG. 1, of the side face of the collector 11 to or with the cathode casing 3 can bear the load which appears when the pouchy tube of solid electrolyte 1 is retained flat.

Even when a large acceleration is imposed on the battery due to vibration by the earth quake or a transportation movement, the pouchy tube of solid electrolyte 1 will not be damaged since the porous conductor 12 and the porous material 13 function as an absorber enabling the mechanical reliability of the sodium-sulfur battery to be particularly improved. For this purpose, it is also practicable to provide the protruded room on a part of the upper portion of the side face of the collector 11, or on all the part thereof otherwise, to join or to integrate this portion to or with the cathode casing 3.

Additionally, similar effect may be obtainable to certain extent when the battery is laid flat with the space between the pouchy tube of solid electrolyte 1 and the cathode casing 3 being filled with a porous conductive material or a porous substance. However, in the present invention, the provision of the collector 11 permits to make the thicknesses of the porous conductor 12 and the porous material 13, both arranged close to the pouchy tube of solid electrolyte 1, be relatively thin, facilitating the support of the pouchy tube of solid electrolyte 1 when the battery capacity unchanged. When the thicknesses of the porous conductor 12 and the porous material 13 remain unchanged contrary to the above, the battery capacity can be made larger. These mean that these practices offer an advantage in that the sodium-sulfur battery having improved mechanical reliability is compatible with the enlargement of the battery capacity.

To improve the mechanical strength of the cathode casing 3, although not illustrated, it is preferred, for avoiding concentration of stress, to give a rounding to the edge of the cathode casing 3 having square or rectangular shape, or to make the top and bottom faces thereof flat-and-parallel and the side faces half-round or half-oval.

When the cathode casing 3 uses aluminum or aluminum alloy, creep deformation may occur on the upper and bottom faces and lateral faces of the flat shaped portion because of pressure difference between the inside and outside of the casing. To avoid this problem, it is preferred to join or to integrate both the top of the protruded room 110 on the collector and the upper portion of side face of the collector 11 to or with the cathode casing 3, by which the deformation of the cathode casing 3 is blocked.

Where required, making the side face, i.e. lateral side in radial direction in FIG. 1, of the collector 11 contact the cathode casing is practicable. Also when appropriate, forming a protrusion on the upper or lateral part of the side face of the collector 11 and making the top of said protrusion contact, join to, or integrate with the cathode casing is practicable. In the case where the top of the protrusion formed on the lower, upper or lateral part of the side face of the collector 11 is joined to or integrated with the cathode casing 3, the end of the collector 11 is not required to be joined to the cathode casing 3; electrical continuity is available through the collector 11.

By making the cross-sectional shape of the cathode casing 3 or the anode casing 2 oval or circular, the stress appears on these casings due to pressure difference between the atmospheric pressure and the internal pressure of these casings is reduced preventing creep deformation easily.

(Embodiment 2)

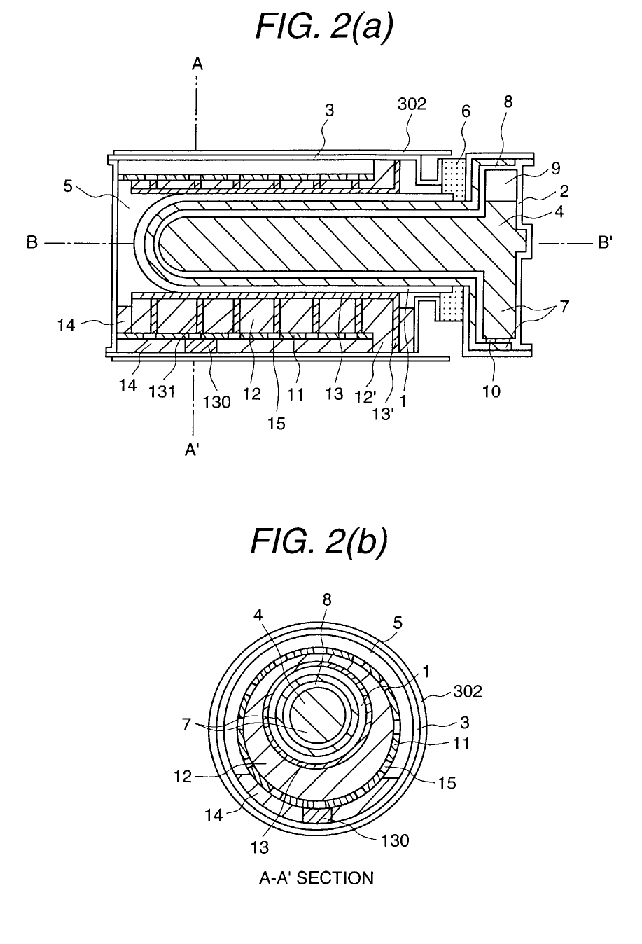

FIG. 2 is a cross-sectional view to show the construction of the sodium-sulfur battery according to the present embodiment. The same numerical numbers as those in FIG. 1 indicate the same elements.

As shown in FIG. 2, the configuration is: the pouchy tube of solid electrolyte 1 is arranged horizontally or aslant; the anode chamber 4 is arranged inside said pouchy tube of solid electrolyte 1 and the cathode chamber 5 outside the same; the collector 11 along the external side face of said pouchy tube 1; and both the porous conductor 12 and the porous material 13 between the side face of said pouchy tube of solid electrolyte 1 and the collector 11. This configuration enables to reconcile enlarging in capacity and improving in efficiency in a battery similarly to the configuration shown in FIG. 1.

In FIG. 2, the cathode casing 3 is made of Al-alloy and cylindrical in shape; a cylindrical container 302, made of SUS or ferroalloy, is arranged outside the cathode casing 3 for prevention of deformation of the cathode casing 3.

In this configuration, the porous conductor 12 and the porous material 13 are provided between the pouchy tube of solid electrolyte 1 in the cathode chamber 5 and the side face of the collector 11, wherein the porous conductor 12 uses a pile of a carbon mat, comprised of carbon fibers or carbon particles and piled axially along the pouchy tube of solid electrolyte 1; then a porous material 131, comprised of fibers or powder of ceramics or glass and being mat-shaped, fills the spaces among said mats that composes said pile.

This porous material 131 has an easy wettability with sodium polysulfide, which composes the cathode active material 14, as well as the porous material 13. This nature promotes vertical movement of the cathode active materiel 14 causing vertical gradation in concentration and composition hard to occur for improved battery efficiency. Thereby, the cathode active material 14 becomes being easily involved in battery reaction offering an advantage of being enlarged battery capacity.

To facilitate this, it is preferred that the porous material 131 contacts the porous material 13 and that said porous material 131 is arranged extending from the surface of the porous material 13 to the surface of the collector 11. As an alternative to the porous material 131, it is also practicable to provide a plate having a through-hole thereon, and being made of metal, ceramics, or polymer, for creating a substantial vacant space among the piled carbon fiber mats composing the porous conductor 12. This manner also promotes the vertical movement of the cathode active material 14.

In this arrangement, retaining the pouchy tube of solid electrolyte 1 horizontally or aslant and arranging the center axis B-B′ of the pouchy tube of solid electrolyte 1 above the center of the cathode casing 3 make the volume of the space between the lower portion of the side face of the pouchy tube of solid electrolyte 1 and the cathode casing 3 larger than that of between the upper portion of the side face of said pouchy tube of solid electrolyte 1 and said cathode casing 3.

Consequently, as stated for an example in FIG. 1, the sodium polysulfide produced in the porous conductor 12 during discharging become easily movable to the space within the cathode chamber outside the collector 11 for upgraded sodium-sulfur battery in discharging performance with improved discharging capacity.

As an alternative to the above, it is also practicable to extend both of a porous conductor 12′ and a porous material 13′, which are provided on the axial end of the collector 11; or otherwise, to provide a porous material 130, which is composed of a similar material as the porous material 13, in a part of the space between the lower part of the side face of the collector 11 along the pouchy tube of solid electrolyte 1 and the cathode casing 3. Thereby, charging continues making the sodium polysulfide in the lower part of the cathode chamber absorbed up for undisturbed supply to the vicinity of the pouchy tube of solid electrolyte 1 to improve charging performance of the battery with an advantage: enlarged charging capacity of the battery.

For improved charging performance, although not illustrated, it is also practicable to extend the porous material 13′ alone to the radial-lower part of the side face of the pouchy tube of solid electrolyte 1. Alternatively, it is also practicable to provide the porous conductive material, together with the porous material 130, in the space, or in a part thereof, between the lower part of the side face of the collector 11 and the cathode casing 3. Otherwise, the porous material 130 alone, or mixture of the porous material 130 and the porous conductive material can be provided therein. Further, providing either the porous material 13′ or the porous material 130, or both, is also acceptable.

For promoted movement of the cathode active material 14 to improve the charging/discharging performance, the porous material 130 and the porous conductive material provided in the lower part of the side face of the collector 11, i.e. the radial-lower part thereof, prefer to be correctly contacted with the porous material 131 and the porous conductor 12. Instead of providing the porous material 130 or the such, it is also practicable to extend the porous material 131 or the porous conductor 12 to the space between the lower part of the side face of the collector 11 and the cathode casing.

Thus, the porous material 13′ and/or the porous material 130, or the porous conductor 12′ is provided in the space between the lower part of the side face of the pouchy tube of solid electrolyte 1 and the cathode casing 3; or in the space, or a part thereof, between the lower part of the side face of the collector 11 and the cathode casing 3. Thereby, the cathode active material 14 pooled in the lower part of the space within the cathode chamber 5 is absorbed up through its contact with these porous material 13′ or 130 substance and porous conductor 12′ to impregnate the porous conductor 12 and the porous material 13 or to be supplied onto the surface of the pouchy tube of solid electrolyte 1. This behavior contributes to battery reaction with improved charging capacity enabling capacity enlargement in the sodium-sulfur battery.

The surface tension is an important property for both the porous conductive materials and the porous substance provided outside the collector 11 or in the space between the collector 11 and the cathode casing 3. There is however no specific requirement for them in the electrical conductivity. This means that a heat treatment at a low temperature when carbon fiber is used, or use of a composite of short fibers of carbon, is acceptable for material cost cut.

The filling density can be made the same as, or higher than, that of the porous conductor 12, or the porous material 13, which fills the space between the side face of the pouchy tube of solid electrolyte 1 and the collector 11. It is however preferred to make the density relatively low from the viewpoint of the mobility of the cathode active material 14 to the vicinity of the pouchy tube of solid electrolyte 1.

Filling a part of the space between the lower part of the side face of the collector 11 and the cathode casing 3 with the porous conductive material or the porous substance is preferred for the following reasons. They are: that the quantity for filling can be reduced rather than filling all the space between the collector 11 and the cathode casing 3, or than filling the lower part thereof below the side face of the cathode casing 3; that the space within the cathode chamber 5 substantially increases allowing to accommodate increased quantity of the cathode active material 14 for enlarged battery capacity; that the sodium polysulfide produced during discharging moves to the space between the lower part of the side face of the collector 11 and the cathode casing 3; and that these make development of the electrical reaction eased during discharging, reducing discharging resistance.

When moving the cathode active material 14 through the space between the lateral end of the collector 11 and the cathode casing 3 or the insulator 6 is intended instead of making the through-hole 15 on the collector 11, it is preferred to extend a part of either the porous conductor 12′ or the porous material 13′ outside the collector 11.

In FIG. 2, the radial-lower portion of the thickness of the porous conductor 12 along the pouchy tube of solid electrolyte 1 is made thicker than that of the radial-upper portion and/or radial-lateral portion by enlarging the lower portion of the clearance between the side face of the pouchy tube of solid electrolyte 1 and the side face of the collector 11 larger than that of the upper portion or lateral portion. It is however still practicable to make the thickness of the radial-lower portion therein be equal to that of upper or lateral portion. Thickening the radial-lower portion of the porous conductor 12 improves charging performance since the sodium polysulfide stays in the lower part of the cathode chamber becomes easy to contact the porous conductor 12.

The constitution shown in FIG. 2 further improves discharging performance of the sodium-sulfur battery. The specific gravity of the sodium polysulfide produced during discharging in the sodium-sulfur battery is greater than that of sulfur. Therefore, the sodium polysulfide droops down to the lower part of the porous conductor 12 as the discharging progresses inviting, meanwhile, floating up of sulfur to cause a gradation of concentration in the cathode active material 14. As the consequence of this, the battery efficiency tends to be greatly lowered because of circulating current caused from uneven distribution of internal electromotive force.

To cope with this tendency, the thickness of the radial-lower part of the porous conductor 12 is made thicker than that of the upper and/or lateral part thereof, wherein the porous conductor 12 is the composite of carbon fiber or powder accommodated between the lower part of the side face of the pouchy tube of solid electrolyte 1 and the side face of the collector 11. Thereby, larger the volume of the lower part of the composite of carbon fiber or powder becomes, larger the sulfur volume impregnating said lower part becomes more than that in upper part and/or lateral part, since carbon and sulfur are wettable each other.

Consequently, even the sodium polysulfide, which is heavier than sulfur in the specific gravity, produced during discharging moves vertically down by the gravity, the vertical distribution of content of the sulfur and sodium polysulfide contained in the composite of carbon fiber or powder has little nonuniformity. This suppresses occurrence of uneven vertical distribution of the electromotive force in the cathode chamber 5 with the maintained high battery efficiency.

In the beginning of discharging, the sulfur content in lower part becomes relatively large. In the sodium-sulfur battery however, the electromotive force is constant as long as the cathode active material 14 contains sulfur. When the entire cathode active material 14 has turned into sodium polysulfide, the specific gravity of the reaction product will change little although the discharging progresses further.

In consideration of vertical movement of the sulfur and sodium polysulfide during discharging therefore, it is particularly preferred to vary the radial thickness of the porous conductor 12 according to places. The thickness should be controlled so that the radial thickness of each part thereof may be thicker corresponding to the location of said part from top to side then bottom. This thickness gradation ensures that the entire sulfur is simultaneously consumed everywhere in the porous conductor 12 to change into sodium polysulfide. This structural arrangement suppresses occurrence of uneven distribution of the electromotive force in the cathode chamber 5 during discharging particularly improving the battery efficiency. This means that, when the radial thickness of the lower part of the porous conductor 12 is thicker than that of upper or lateral part thereof, consequently the composition of the cathode active material 14 during discharging is homogenized with the effect of being improved battery efficiency.

The cathode casing 3 in FIG. 2 is cylindrical, i.e. its cross-sectional structure is round. Therefore, the cathode casing 3 is given a high mechanical strength against thermal stress due to temperature variation rendering an advantage of being high reliability to the battery. When the cathode casing 3 uses aluminum or aluminum alloy, a particular problem of creep deformation tends to occur on the cathode casing 3 because of thermal stress due to temperature variation in the battery. This deformation is easily prevented by making the cathode casing 3 cylindrical to relax the stress thereon. For this purpose, it is particularly preferred to provide a cylindrical container 302 of SUS or carbon steel outside the cathode casing 3.

It is practicable to form the cathode casing 3 in oval in its cross-sectional shape although not illustrated. This oval shape assures increased mechanical reliability more than that in the cathode casing 3 being square or rectangular in its cross-sectional shape shown in FIG. 1.

When the cathode casing 3 is a rectangular solid as shown in FIG. 1, i.e. the top and bottom faces and/or both of side faces thereof are parallel-and-flat, it is preferred to round the corners in sectional shape, to make top and bottom faces parallel-and-flat, and to make both of side faces round or oval; each to escape from stress concentration on corners.

The following practices will reduce the creep in the cathode casing 3 of aluminum or aluminum alloy. They are: to control the sum of pressures of vapor and gas, such as inert gas, in the cathode chamber 5 to be almost the same as the atmospheric air pressure while operation; to use clad metal such as SUS-aluminum in the cathode casing 3; to provide reinforcement outside the cathode casing 3 when the gas pressure in the cathode chamber 5 is high; and to provide a reinforcement of SUS, aluminum alloy or carbon steel having corrosion resisting layer inside the cathode casing 3 when said gas pressure is low. Thereby, the prevention of deformation of the cathode casing 3 becomes attainable.

In the sodium-sulfur battery shown in FIGS. 1 and 2 having the structure according to the present invention, the cathode resistance is determined mainly by the collector 11, the porous conductor 12, and the porous materials 13 and 131. The volume of the cathode casing 3 has less relation to the battery resistance. Because of this, reduced space between the side face of the pouchy tube of solid electrolyte 1 and the collector 11 gives the porous conductor 12 smaller radial resistance with improved battery efficiency. Further, enlarged battery capacity is attainable by increasing the space between the collector 11 and the cathode casing 3 to expand the volume of the cathode chamber.

As the consequence of these, enlarging battery capacity becomes practicable maintaining the battery resistance low but with less number of parts. Thereby, battery cost cutting is easily realized to obtain a large capacity battery having high practicality.

Increasing the length of the pouchy tube of solid electrolyte 1 more than the diameter thereof reduces the ratio of the internal volume of the pouchy tube of solid electrolyte 1 to its surface area relatively small.

Then, the current density per unit surface area of the pouchy tube of solid electrolyte 1 is reduced for the battery operation within the specified time length compared with the one in the case where the pouchy tube of solid electrolyte 1 having a diameter of similar or lager dimension to its length is used. As a result of this, the voltage variation expressed by Current×Resistance becomes small with the advantage of being improved battery efficiency.

This effect is particularly prominent when the pouchy tube of solid electrolyte 1 is lengthened for the purpose of large-sizing the battery. Therefore, use of the present structure enables the battery to reconcile large-sizing, i.e. larger capacity, with improved efficiency.

(Embodiment 3)

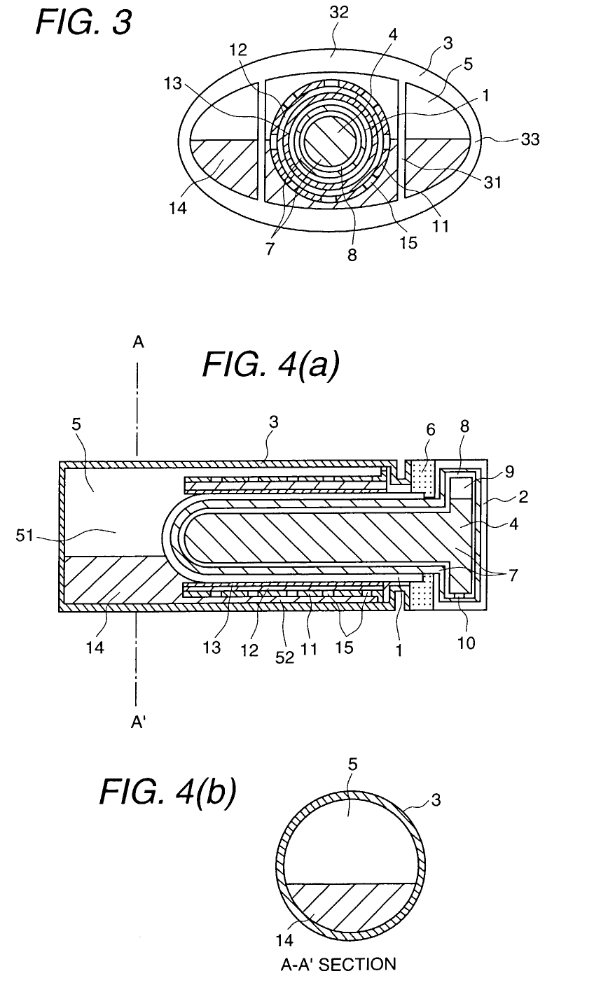

FIG. 3 is a cross-sectional view to show the construction of the sodium-sulfur battery according to the present embodiment. The same numerical numbers as those in FIGS. 1 and 2 indicate the same elements.

As shown in FIG. 3, the configuration is: the pouchy tube of solid electrolyte 1 is arranged horizontally or aslant; and the anode chamber 4 is arranged inside said pouchy tube of solid electrolyte 1 and the cathode chamber 5 outside the same. Further, the collector 11 is provided along the side face of the pouchy tube of solid electrolyte 1. The space between the side face of the pouchy tube of solid electrolyte 1 and the collector 11 has the porous conductor 12 and the porous material 13.

The cross-sectional shape of the cathode casing 3 in FIG. 3 is oval. The pouchy tube of solid electrolyte 1 is laid flat so that the minor axis in its cross-section, i.e. the minor axis of the oval, may come to be in vertical namely in plumb-bob direction.

This structure makes the clearance between the lower part of the side face of the collector 11 and the side face of the cathode casing 3 narrow. Thereby, the sodium polysulfide, which is a part of the cathode active material 14, pooled in the lower part of the cathode chamber 5 comes easily to contact the porous conductor 12 and the porous material 13 improving charging performance. Although not illustrated, it is also practicable to make the lower part of the side face of the collector 11 contact or be joined to the cathode casing 3 for particular improvement in charging performance and in mechanical reliability.

In this structure, the lateral direction of the cross-section of the cathode casing 3 is the major axis direction, the major axis of the oval shape. Therefore, the lateral spread of the cathode chamber 5 is large. This large spread retains the liquid level of the sodium polysulfide, which occupies a part of the cathode active material 14, reduced even the sodium polysulfide expands in its volume due to the discharging development. Further, this mechanism maintains a portion of the area on the porous conductor 12 in contact with the liquid face of the sodium polysulfide in the cathode chamber 5 being reduced like those in the structure shown in FIG. 1, wherein the volume of the lower part of the space between the side face of the pouchy tube of solid electrolyte 1 and the side face of the cathode casing 3 is made larger than that of the upper portion. Then, the discharging performance is improved by eased emission of the sodium polysulfide produced in the porous conductor 12 into the space within the cathode chamber 5.

Making the sectional shape of the cathode casing 3 oval gives advantages of being reduced occurrence of creep deformation more than that in the rectangular solid shown in FIG. 1 with enhanced mechanical reliability.

The structure shown in FIG. 3 is applicable not only to the cases in which the lower part of the space between the side face of the pouchy tube of solid electrolyte 1 and the side face of the cathode casing 3 is the same as the upper part thereof but also to the case, although not illustrated, where said lower part is larger than that of upper part, or is smaller as well.

In these structures, the lower part of the space between the side face of the collector 11 and the side face of the cathode casing 3 can be made relatively narrow compared with the case where the cathode casing 3 is round or square as shown in FIGS. 1 and 2 when the cross sectional area of the cathode casing 3 is kept unchanged. Moreover, the lateral-volume in the cathode casing 3 can be made relatively large enabling the battery capacity to be enlarged by improved discharging performance.

(Embodiment 4)

FIG. 4 is a cross-sectional view to show an example of the construction of the sodium-sulfur battery according to the present embodiment.

The sectional structure of the cathode casing 3 along the axis perpendicular to the axis of the pouchy tube of solid electrolyte 1 is shaped round, otherwise rectangular or oval although not illustrated; the axial length of the cathode casing 3 is given sufficiently longer dimension more than that of the pouchy tube of solid electrolyte 1.

This configuration enlarges the lateral volume of the cathode chamber 5 when the battery is laid flat. This laterally enlarged volume keeps the portion of the area in the porous conductor 12 which contacts the sodium polysulfide in the cathode chamber 5 small improving the discharging performance even the volume of the sodium polysulfide that forms a part of the cathode active material 14 expands.

This effect is also realized in the cases not only that the lower part of the volume of the space between the side face of the pouchy tube of solid electrolyte 1 and the side face of the cathode casing 3 is larger than the upper part thereof, but also that said part of volume is the same as or smaller than the upper part thereof.

In this structure, it is preferred that the volume of a cathode chamber 51 for the part thereof axially-outward from the bottom of the pouchy tube of solid electrolyte 1 is more than the volume of the lower part of a space 52 between the side face of the collector 11 along the pouchy tube of solid electrolyte 1 and the side face of the cathode casing 3, wherein said lower part of the space 52 means the part below the center axis B-B′ of the pouchy tube of solid electrolyte 1. Thereby, the liquid level of the sodium polysulfide becomes about ½ or less compared with the case that the volume of the cathode chamber 5 for the part axially-outward from the bottom of the pouchy tube of solid electrolyte 1 is smaller than the volume of the space 52; the discharging property particularly improves.

Where the volume of lower part of the space between the side face of the pouchy tube of solid electrolyte 1 and the side face of the cathode casing 3 is smaller than that of the upper part thereof, the sodium polysulfide comes to easily contact the porous conductor 12 and the porous material 13. This improves the charging performance and the battery capacity is particularly enlarged.

Further, where the cathode casing 3 is cylindrical, the mechanical strength becomes largely resistible against the thermal stress caused from the temperature rise and fall. Moreover, the cathode casing 3 will have less creep deformation with high reliability in battery performance.

To improve a battery performance, the internal resistance of the battery prefers to be made small as much as possible. For reducing the internal resistance of the battery, it is preferred to use Al or Al-alloy, or clad metal like Al-alloy clad with SUS in the collector 11. With the similar consideration, the cathode casing 3, which is joined to or integrated with the collector 11, also prefers to use Al, Al-alloy, or clad metal.

When the cathode casing 3 uses metals other than Al, disadvantages such as significant difficulty in joining to or integration with the collector 11, increased electrical resistance of a cathode casing, or corrosion by sodium polysulfide or sulfur may arise.

On the other hand, when the cathode casing 3 uses Al or Al-alloy, the cathode casing 3 suffers creep deformation problem on its sectional major axis by the pressure difference between the external air and the internal air since the operating temperature of the sodium-sulfur battery is as relatively high as about 330° C.

For prevention of the creep deformation, it may be an idea to roughly equalize the operating pressure in the cathode chamber 5 with the atmospheric pressure. However, this method would give an incomplete prevention against such creep deformation. Because, the internal pressure of the cathode chamber 5 will become below the atmospheric pressure when the battery operation ceases and the battery temperature falls down such occasion.

To cope with this creep deformation problem, the embodiment shown in FIG. 3 employs an oval shape in the sectional structure of the cathode casing to minimize the deformation by the pressure difference more than that in a rectangular solid. Further, the structure provides a supporting plate 31 inside the cathode casing 3 vertically along its minor axis to prevent deformation of the cathode casing 3 on its major axis for enhanced battery reliability.

Securing the battery capacity using this structure as demanded requires the cathode active material 14 in the cathode chamber 5 to move between the inside and outside of the supporting plate 31 shown in FIG. 3. Therefore, it is necessary for responding to this requirement to enable the cathode active material 14 to move between inside and outside the supporting plate 31. Although not illustrated, it would facilitate this movement to provide a through-hole on the supporting plate 31, or to provide a room in the cathode chamber 5 for the portion between the longitudinal-end of the supporting plate 31 (axial direction of the pouchy tube of solid electrolyte 1) and the cathode casing 3. In this, providing such room between the longitudinal-end of the supporting plate 31 and the insulator 6 may also be practicable.

The preferred opening area of the through-hole and the one in said room is within 5 to 50% of the area of the supporting plate 31. If these areas are too small, the movement of the cathode active material 14 is disturbed causing the battery capacity to be susceptible to decrease. If, contrary to this, these are too large, the strength of the supporting plate decreases imposing a problem on the cathode casing 3 in eased occurrence of the creep deformation.

Using Al or Al-alloy in the supporting plate 31 offers an advantage of being a simplified process in manufacturing the battery since such material accepts an integral extrusion of the cathode casing and the supporting plate.

Further to the above although not illustrated, it is practicable to prevent the creep deformation in the cathode casing 3 by means of providing a depression inside the cathode casing 3 and fitting the supporting plate 31, prepared separately, into said depression. Thereby, the structure gives an advantage in that making the trough-hole on the supporting plate 31 is easy.

To prevent the creep deformation keeping the weight of the cathode casing 3 relatively light, it is useful to make the wall thickness of the proximity to a minor axis 32 (short-axis-wise) of the cathode casing 3 thicker than that to a major axis 33 (long-axis-wise), as shown in FIG. 3. With this manner, making the wall thickness of the proximity to the minor axis 32 about 5 to 10 mm, for example, prevents the creep deformation in the cathode casing 3 for particularly enhanced reliability of the battery even the wall thickness of the proximity to the major axis 33 is about 2 to 4 mm.

This means that larger wall thickness of the cathode casing 3 along its major-axis-wise than that along its minor-axis-wise will suppress the deformation along the major axis that occurs relatively easily. When the cathode casing 3 uses Al-alloy, the supporting plate 31 and the cathode casing 3 can be integrally extruded offering an advantage of being high in productivity of the cathode casing 3.

The anode casing 2, when Al or Al-alloy is used therein although not illustrated, also encounters the creep deformation problem. This problem however can be solved by means of using a metal having comparatively high strength under high temperatures like SUS for the sodium container 8 and making the internal pressure of the anode chamber 4 at the operating temperature to be the same as or below the atmospheric pressure, which facilitates the sodium container 8 to suppress the deformation in the anode casing 2. For this purpose, it is preferred to increase the strength of the sodium container 8 against deformation by giving relatively large wall thickness to the sodium container 8 or providing a depression or a salient on the side face thereof.

As can be seen in FIG. 2, when the structure has the anode casing 2 close to the through-hole 10 on the sodium container 8, a salient, although not illustrated, is provided on the sodium container 8 adjacent to the through-hole. Thus, choking the through-hole 10 can be prevented by said salient even when the anode casing 2 deforms toward inside to contact the sodium container 8.

It is also practicable to make the outer-lower portion of the cathode casing 3 flat in FIG. 3 although not illustrated. Thereby, the battery, when placed flat, becomes hard to move with an advantage of being improved posture stability.

It also is practicable to make both the outer-upper and outer-lower portion of the cathode casing 3 flat. By this, the interstices between vertically stacked batteries and the clearances between the insulation container and the battery-top and -bottom can be reduced when multiple batteries are to be installed in the insulating container that composes a module. The interstice and clearance thus reduced give an advantage of being increased energy density of the module because of improved accommodation density of batteries.

Making the sectional shape of the cathode casing 3 rectangular, although not illustrated, to lay the battery with its minor axis vertical improves the energy density of the module that accommodates multiple unit cells and the charging/discharging performance of the battery likewise as stated for FIGS. 1 and 3. Since the creep deformation may particularly tends to occur on the cathode casing 3 in this structure, it is therefore required to install the supporting plate 31 vertically along the minor axis in the sectional shape thereof likewise as shown in FIG. 3 for prevention of such deformation.

If needed, it is useful to form the sectional shape of the supporting plate 31 into figure-T to provide a supporting member also along the major axis in the sectional shape thereof. Further preference in the structure is to give larger wall thickness to the cathode casing 3 along its major axis than that along its minor axis. Thereby, the deformation on the major axis thereof that occurs comparatively easy can be suppressed.

Where the cathode casing 3 shaped in rectangular uses Al or Al-alloy, the wall thickness thereof is increased, particularly, the sectional thickness along its major axis is made thicker than that along the minor-axis to prevent the deformation by the creep. Alternatively, the deformation in the cathode casing 3 is preferred to be prevented by use of clad metal with SUS or the like or by use of a rectangular container similar to the cylindrical container 302 shown in FIG. 2. When the cathode casing 3 uses Al-alloy, integrated extrusion of the cathode casing 3 with the supporting plate 31 is practicable similarly as explained for FIG. 3. It is also practicable to provide a depression inside the cathode casing 3 to fit the supporting plate 31 thereinto.

In a definite example as shown in FIG. 1, the pouchy tube of solid electrolyte 1 was a cylindrical pouch made of lithium doped sintered β″ alumina of 60 mm in diameter, 1000 mm in length, and about 1.5 mm in wall thickness.

As the material, clad metal of Al-alloy with SUS was used for the anode casing 2 and the cathode casing 3; SUS for the sodium container 8; and composite of Al-alloy plated with chromium or thermally splayed with iron/chromium alloy, or stellite-6 or stellite-6B for the collector 11, wherein said composite was formed into a barrel having a through-hole 15 thereon.

Sectional shape of the collector 11 was a round having a protruded room 110 at the bottom thereof. Although not illustrated, the protruded room 110 contacted the side face of the cathode casing 3 and the lateral end of the collector 11 contacted the bottom of the cathode casing 3 formed in a rectangular solid.

The insulator 6 used a sintered ring of alumina. The insulator 6 was glass-joined to the opening of the pouchy tube of solid electrolyte 1. The end of the anode casing 2 and the end of the cathode casing 3 were arranged on the surface of the sintered ring. Then the end of the anode casing 2, the end of the cathode casing 3, and the insulator 6 were thermo-pressure welded using Al-Si based alloy foil.

The sodium container 8 was filled with sodium 7 and an inert gas 9 comprised of Ar having about 0.01 MPa of pressure, which was then sealed. Thereby, the internal surface of the pouchy tube of solid electrolyte 1 was made to be covered with the sodium 7 which came through the through-hole 10 on the side face of the sodium container 8 being pressed by the pressure of the inert gas 9.

The space between side faces of the pouchy tube of solid electrolyte 1 and the collector 11 was filled with the pile of the porous conductor 12 comprised of a ring-shaped PAN-based carbon fiber mat having a radial thickness of about 9 mm. Said space was further filled with the porous material 13 comprised of composite of alumina fibers having about 0.3 mm of thickness. Both said porous material 13 and said porous conductor 12 were extended until they reached the lower part of the protruded room 110, i.e. the top thereof. At the final process in the fabrication, the cathode chamber 5 was impregnated with sulfur as the cathode active material 14 and the cathode casing 3 was sealed to complete the sodium-sulfur battery fabrication.

In this structure, the battery is laid flat so that the through-hole 10 on the sodium container 8 and the protruded room 110 may position downside. Further, the center axis B-B′ of the pouchy tube of solid electrolyte 1 is arranged above the center of the cathode chamber 5 so that the lower part of the clearance between the side face of the pouchy tube of solid electrolyte 1 and the side face of the cathode casing 5 may become larger than that of upper part thereof.

The sodium-sulfur battery thus fabricated was operated at 330° C. in a flat posture. The operation showed that the battery capacity was as large as about 2500 Ah with the contribution by the battery reaction into which almost all the cathode active material 14 therein was involved, and that the internal resistance achieved the small value of about 1 m. Thus, the compatibility of the large battery capacity with the high efficiency has been realized. In this battery, the use of the collector 11 enables the cathode casing 3 to be enlarged for increased battery capacity without expansion of the pouchy tube of solid electrolyte 1. Therefore, the structure is particularly suitable for cost reduction.

What is claimed is:

1. A sodium-sulfur battery comprising an anode chamber having a pouchy tube of solid electrolyte inside of which is filled with liquid sodium; a cathode chamber arranged outside of said pouchy tube of solid electrolyte, said cathode chamber accommodating a cathode active material comprising at least one of sulfur and sodium polysulfide; a collector provided inside of said anode chamber; and at least one of a porous conductor and a porous material that fills the space between said collector and the side face of said pouchy tube of solid electrolyte, wherein said pouchy tube of solid electrolyte is laid horizontally or aslant; said collector, in its cross-sectional construction, has a protruded room on at least a part thereof which faces the lower section of the side face of said pouchy tube of solid electrolyte; and said protruded room is filled with at least one of said porous conductor and said porous material.

2. A sodium-sulfur battery according to claim 1, wherein a part of at least one of said porous conductor and said porous material is extended continuously from the vicinity of the side face of said pouchy tube of solid electrolyte to the top of said protruded room.

3. A sodium-sulfur battery according to claim 1 or claim 2, wherein at least one of members of the group of portions consisting of said top of protruded room, a part of the upper section of side face of said collector, and the whole of said upper section is arranged onto a cathode casing that forms said cathode chamber in a practice selected from the group of joining practices consisting of contacting, jointing, and integrating.

4. A sodium-sulfur battery comprising an anode chamber having a pouchy tube of solid electrolyte inside of which is filled with liquid sodium; a cathode chamber arranged outside of said pouchy tube of solid electrolyte, said cathode chamber accommodating a cathode active material comprising at least one of sulfur and sodium polysulfide; a collector provided inside of said anode chamber; and at least one of a porous conductor and a porous material that fills the space between said collector and the side face of said pouchy tube of solid electrolyte, wherein said pouchy tube of solid electrolyte is laid horizontally or aslant; volume of the space produced between the lower section of the side face of said pouchy tube of solid electrolyte and a cathode casing that forms said cathode chamber is larger than volume of the space produced between the upper section of the side face of said pouchy tube of solid electrolyte and said cathode casing that forms said cathode chamber.

5. A sodium-sulfur battery according to claim 4, wherein said collector, in its cross-sectional construction, has a protruded room on at least a part thereof which faces the lower section of the side face of said pouchy tube of solid electrolyte; and said protruded room is filled with at least one of said porous conductor and said porous material.

6. A sodium-sulfur battery according to claim 5, wherein a part of at least one of said porous conductor and said porous material is extended continuously from the vicinity of the side face of said pouchy tube of solid electrolyte to the top of said protruded room.

7. A sodium-sulfur battery comprising an anode chamber having a pouchy tube of solid electrolyte inside of which is filled with liquid sodium; a cathode chamber arranged outside of said pouchy tube of solid electrolyte, said cathode chamber accommodating a cathode active material comprising at least one of sulfur and sodium polysulfide; a collector provided inside of said anode chamber; and at least one of a porous conductor and a porous material that fills the space between said collector and the side face of said pouchy tube of solid electrolyte, wherein the cross-section of a cathode casing that forms said cathode chamber is oval; and said pouchy tube of solid electrolyte is laid horizontally or aslant so that the minor axis of said oval shape may position vertical.

8. A sodium-sulfur battery comprising an anode chamber having a pouchy tube of solid electrolyte inside of which is filled with liquid sodium; a cathode chamber arranged outside of said pouchy tube of solid electrolyte, said cathode chamber accommodating a cathode active material comprising at least one of sulfur and sodium polysulfide; a collector provided inside of said anode chamber; and at least one of a porous conductor and a porous material that fills the space between said collector and the side face of said pouchy tube of solid electrolyte, wherein said pouchy tube of solid electrolyte is laid horizontally or aslant; and volume of a space in said cathode chamber for the axially outer portion from the bottom of said pouchy tube of solid electrolyte is larger than volume of a space produced between a part of side face of said collector which faces said pouchy tube of solid electrolyte and the lower section of the side face of said cathode casing that forms said cathode chamber.

9. A sodium-sulfur battery according to any one of claims 1, 4, 7, or 8, wherein the space produced between one of the lower portions of the side faces of said collector and said pouchy tube of solid electrolyte, and a cathode casing that forms said cathode chamber is filled with at least one of a porous conductor and a porous material.

10. A sodium-sulfur battery comprising an anode chamber having a pouchy tube of solid electrolyte inside of which is filled with liquid sodium; a cathode chamber arranged outside of said pouchy tube of solid electrolyte, said cathode chamber accommodating a cathode active material comprising at least one of sulfur and sodium polysulfide; a collector provided inside of said anode chamber; and at least one of a porous conductor and a porous material that fills the space between said collector and said pouchy tube of solid electrolyte, wherein the cross-section of a cathode casing that forms said cathode chamber is any one of shapes of oval and rectangular; said pouchy tube of solid electrolyte is laid horizontally or aslant so that the minor axis in said cross-sectional shape may position vertical; and a supporting plate is provided in said cathode casing and is installed vertically along the minor axis thereof.

11. A sodium-sulfur battery according to claim 10, wherein the distribution of wall thickness of said cathode casing is given one of features that the wall thickness along the major axis of the rectangular shape thereof is larger than that along the minor axis and that the wall thickness in proximity to the minor axis of the oval shape in said cathode casing is larger than that in proximity to the major axis thereof.

12. A sodium-sulfur battery according to claim 10, wherein said sodium-sulfide battery is given at least one of constitutions selected from the group of constitution styles consisting of that said supporting plate has a through-hole thereon and that said cathode chamber has a room therein at the portion between the crosswise-end of said supporting plate and said cathode casing.
